(19) United States
(12) Patent Application Publication
(10) Pub. No.: US 2002/0117515 A1
(43) Pub. Date: Aug. 29, 2002

(54) Syringe with disposable needle

(76) Inventor: Chih-Ming Lee, Taichung City (TW)

Correspondence Address: BAKER & BOTTS L.L.P., 30 Rockefeller Plaza, New York, NY, 10112-0228, US

(21) Appl. No.: 09/794,658

(22) Filed: Feb. 27, 2001

(51) Int. Cl. B67D 5/52

(52) U.S. Cl. 222/137

(57) ABSTRACT

A syringe and needle assembly having a protective needle shield, which is structurally simple and provides greater safety in use, is disclosed. The syringe and needle assembly comprises a barrel; a plunger disposed slidably inside the barrel; a needle unit including a needle hub and a needle securely affixed to the needle hub; and a cap disposed about the needle unit and the barrel as a protective cover. The cap has a curved wall covering the needle unit and the barrel, the wall having an open end adjacent to the barrel, a closed end adjacent to the needle, and an opening extending longitudinally from the open end to the closed end for lateral insertion of the barrel and the needle unit into the cap. The opening is in communication with the open end and has a width sufficient to permit passage of the barrel along a direction transverse to the opening.

### BACKGROUND OF THE INVENTION

1. Field of the Invention

The present invention relates to a syringe and needle assembly, more particularly to a syringe with disposable needle having a protective needle shield, which is structurally simple and provides greater safety in use.

2. Description of the Related Art

One of the sources of infection with the AIDS, hepatitis B or hepatitis C virus is through shared use of syringe needles. The use of disposable needles is therefore a basic preventive measure to avoid contracting the aforementioned diseases. As shown in FIGS. 1 and 2, the conventional syringe and needle assembly currently in use generally comprises a barrel 1, a needle unit 2, a plunger 3 and a cap 4. The barrel 1 is of a substantially hollow cylindrical form having an open front end on which is attached the needle unit 2, and an open rear end from which the plunger 3 is slidably disposed into the barrel 1. The needle unit 2 includes a needle hub 201 and a needle 202 extending from the needle hub 201. The forward end 301 of the plunger 3 is snugly fitted against, but nevertheless slidable along, the inner wall surface of the barrel 1, while the rear end 302 which serves as the thumb rest protrudes from the barrel 1. The cap 4 is of a substantially tubular form having a closed end and an open end 401 which is fitted around the outer edges of the needle hub 201 of the needle unit 2, with the needle 202 enclosed within the cap 4. The cap 4 is removed from the needle unit when the syringe and needle assembly is used, and is sleeved back after use to ensure that the needle 202 is covered and, thereafter, the needle unit 2 is detached from the barrel 1, along with the cap 4 covering the needle 202, for safe disposal.

While the use of disposable syringe needles does ensure the safety of the person or patient on which they are used, the great risk posed thereby to medical and nursing personnel engaged in therapeutic work, who has to handle such disposable syringe needles in injection or extraction procedures, has not been eliminated. Specifically, to sheath the needle for safe disposal after an injection or extraction procedure, the medical or nursing personnel holds the cap 4 in one hand and the syringe with needle in the other hand, and the needle is advanced toward the open end 401 of the cap 4. Since the diameter of the open end of the cap 4 is limited, the insertion of the needle must be done carefully, or the medical or nursing personnel might accidentally prick his hand or fingers with the needle through his own negligence or by an unexpected impact of external force on him. In view of this, the cap 4 is not fairly practical.

There are several solutions proposed in the art directed to the above-described shortcoming of the conventional syringe and needle assembly. For instance, the syringe needle has been modified into an inwardly retracting form, or the cap has been modified to be connected to the barrel and capable of advancing and retreating movements. However, such solutions are derived by extensive alteration of the basic structure of the syringe which not only renders the resultant structure more complicated but to be of much different specifications from those of the generally used syringes, leading to inconvenience in operation and increase in the production costs.

### SUMMARY OF THE INVENTION

With a view to alleviating the shortcoming of the prior art, the inventor through several years of studies has come up with the present invention.

A primary object of the present invention is to provide a syringe and needle assembly which provides greater safety in use, by providing a cap of improved construction such that the needle is sheathed into the cap by lateral insertion, thereby the drawback of accidental pricking of a user's fingers caused by longitudinal insertion practiced in the prior art can be eliminated.

Accordingly, the present invention provides a syringe and needle assembly comprising a barrel having two open ends; a plunger disposed slidably inside said barrel and extending outward through one of said open ends of said barrel; a needle unit including a needle hub attached to the other one of said open ends of said barrel, and a needle securely affixed to said needle hub; and a cap disposed about said needle unit and said barrel as a protective cover and having a curved wall covering said needle unit and said barrel, said wall having an open end adjacent to said barrel, a closed end adjacent to said needle, and an opening extending longitudinally from said open end to said closed end for lateral insertion of said barrel and said needle unit into said cap, said opening being in communication with said open end, said opening having a width sufficient to permit passage of said barrel along a direction transverse to said opening.

In particular, the cap is sectioned into a substantially tubular first sheath part for receiving the needle unit and a generally semi-cylindrical second extended part, with a cross section greater than the first sheath part, for receiving the barrel, the two parts being preferably formed as one piece.

The structure of the cap allows lateral insertion of the needle therein, thus preventing a user's finger(s) from being accidentally pricked or pierced by the needle during the inserting operation of the needle into the cap.

### BRIEF DESCRIPTION OF THE DRAWINGS

Other features and advantages of the present invention will become apparent in the following detailed description of a preferred embodiment with reference to the accompanying drawings, in which:

FIG. 1 is an exploded perspective view of a conventional syringe and needle assembly;

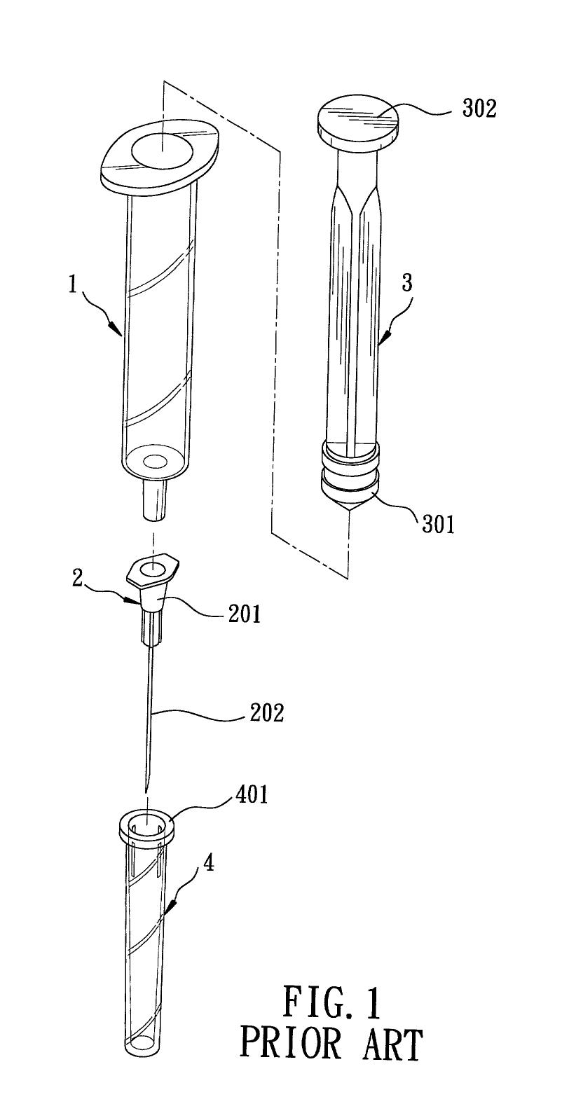

FIG. 2 shows a longitudinal cross sectional view of the conventional syringe and needle assembly;

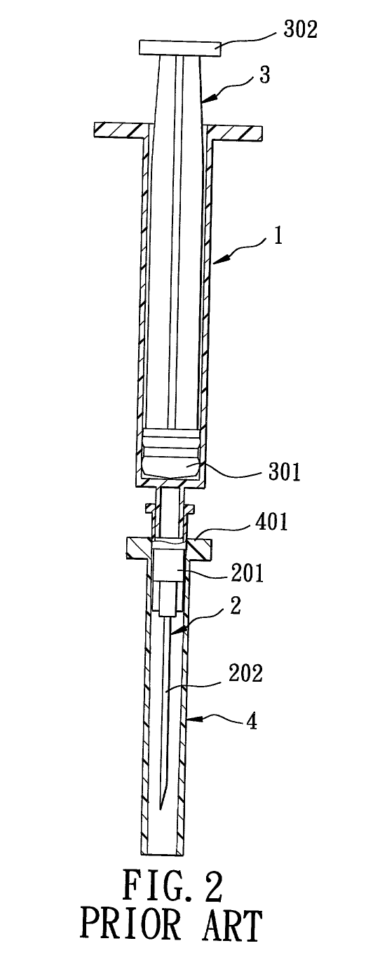

FIG. 3 is an exploded perspective view of a preferred embodiment of needle and syringe assembly according to the present invention;

FIG. 4 is a perspective view of the preferred embodiment;

FIG. 5 shows a longitudinal cross sectional view of the preferred embodiment; and

FIG. 6 shows the preferred embodiment in the operational condition thereof.

### DETAILED DESCRIPTION OF THE PREFERRED EMBODIMENT

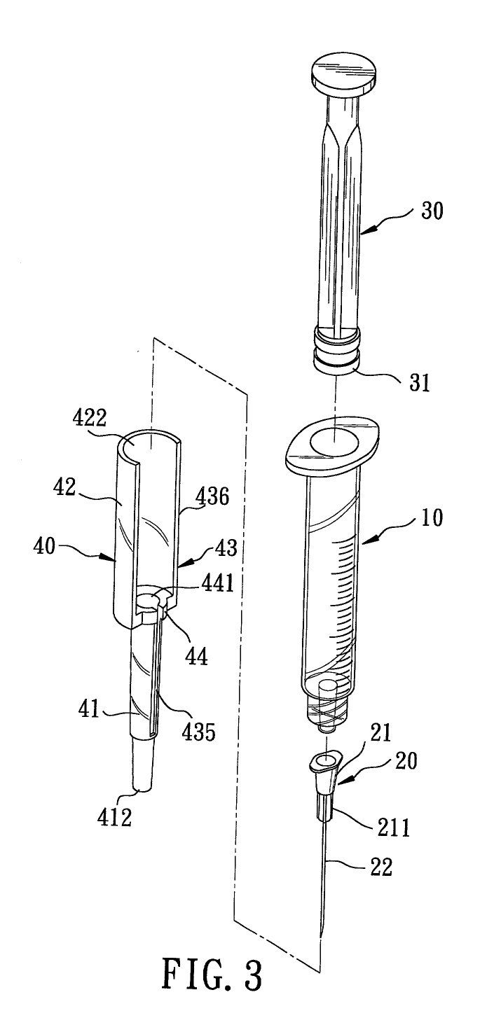

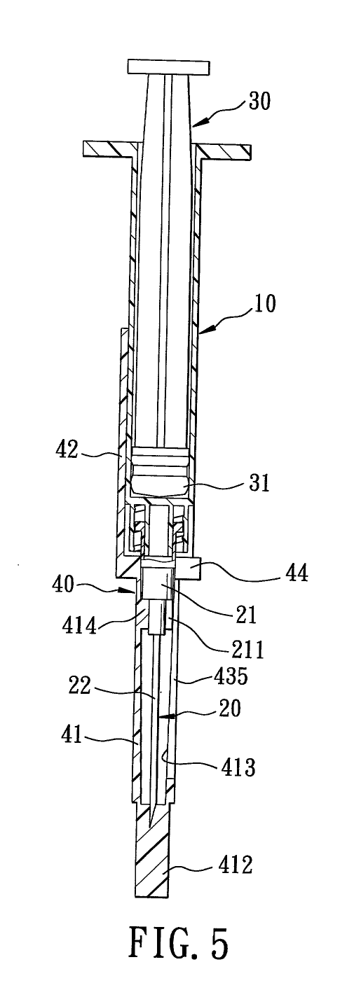

The syringe and needle assembly of improved construction according to the present invention will now be described with reference to FIGS. 3, 4 and 5. As shown, the syringe and needle assembly comprises a barrel 10, a needle unit 20, a plunger 30 and a cap 40. Except for the cap 40, the structure and arrangement of the barrel 10, needle unit 20 and plunger 30 in combination are generally the same as those of the conventional hypodermic syringe and needle, in which the needle unit 20 includes a needle hub 21 and a needle 22 securely affixed to the needle hub 21 and the barrel 10 is of a generally hollow cylindrical form and has an open front end to which the needle hub 21 is attached, and an open rear end for insertion of the plunger 30 into the barrel 10. The plunger 30 is slidably disposed inside the barrel 10 and extends outward through the rear open end of the barrel 10. The forward end of the plunger 30 is provided with a rubber stopper 31 which snugly fits against, but is nevertheless slidable along, the inner wall surface of the barrel 10. The rear end of the plunger 30 is formed into a thumb rest. The needle hub 21 has radial ridges 211 around the outer surface thereof.

The cap 40 is disposed about the needle unit and the barrel 10 to serve as a protective sheath or cover. The cap 40 is of a substantially tubular form covering the needle unit 20 and the barrel 10, and has an open end 422 adjacent to the barrel 10 and a closed end 412 adjacent to the needle 22. The wall of the cap 40 is curved and has an opening 43 extending longitudinally from the open end 422 to the closed end 412 to enable lateral insertion of the barrel 10 and needle unit 20. The opening 43 is in communication with the open end 422.

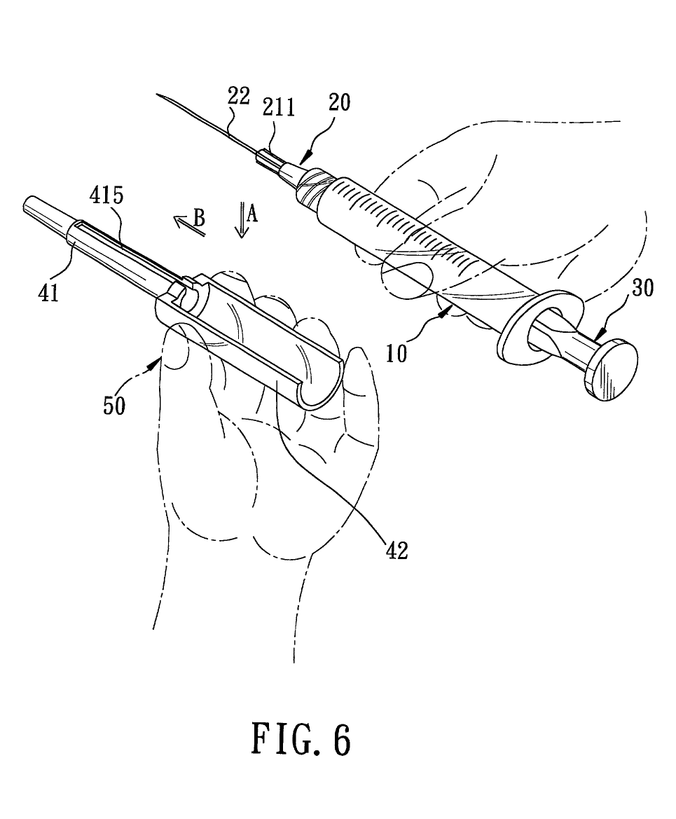

In particular, the cap 40 is sectioned into a first sheath part 41 for receiving the needle unit 20 and a second extended part 42 for receiving the barrel 10. Preferably, the first sheath part 41 and the second extended part 42 are formed as one piece. The first sheath part 41 is substantially tubular and has a substantially annular shoulder 44 formed at the juncture of the first sheath part 41 and the second extended part 42. The opening 43 includes a wide aperture 436 in the second extended part 42 with a width sufficient to permit passage of the barrel 10 along a direction transverse to the opening 43 (as best shown by arrow A in FIG. 6), and is narrowed to form a slit 435 in the first sheath part 41 which extends, and tapers gradually, from the shoulder 44 to the closed end 412. The width of the slit 435 near the closed end 412 should be greater than the diameter of the needle 22 to permit passage of the needle 22. The annular shoulder 44 has a through-hole 441 for insertion of the needle hub 21 from the second extended part 42 into the first sheath part 41. The first sheath part 41 tapers gradually from the annular shoulder 44 to the closed end 412 to form a generally conical wall 413. The first sheath part 41 is further provided with radial teeth 414 at the inner peripheral surface thereof near the annular shoulder 44. The radial teeth 414 engage the radial ridges 211 on the needle hub 21 when the needle 22 is sheathed in the cap 40 and the cap 40 is rotated against the needle unit 20, thereby fixing the cap 40 to the needle unit 20 with the needle 22 sheathed therein. The closed end 412 is of sufficient thickness along a longitudinal direction so as to be pierced only partially by the needle 22 when the needle unit 20 is inserted in the cap 40, thereby positioning the inserted needle 22 at the exact central position of the closed end 412.

The second extended part 42 is of a cross section greater than the first sheath 41 and is generally semi-cylindrical. Preferably, the second extended part 42 has an angular width greater than 180 degrees and is shorter than the barrel 10.

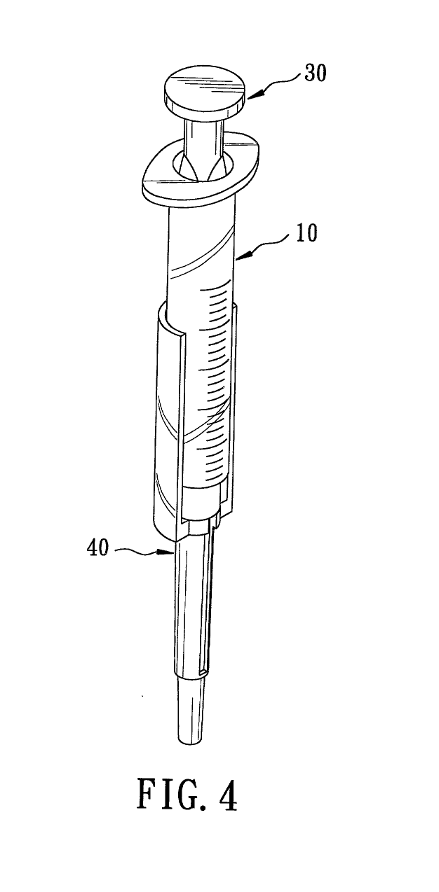

The operation of the present invention in use, as well as the expected effects achieved thereby, will now be described with reference to FIGS. 4, 5 and 6.

To carry out an injection or extraction procedure the barrel 10 along with the needle unit 20 is detached from the cap 40 to uncover the needle 22, and the plunger 30 is either pushed or drawn after the needle is injected. After the injection or extraction operation, to detach the needle unit 20 from the barrel 10 for safe disposal, the user holds the second extended part 42 of the cap 40 at a position near the juncture of the first sheath part 41 and the second extended part 42 with one hand, and the barrel 10 with the other hand, the barrel 10 being held above the cap 40, with the tip of the needle 22 of the needle unit 20 positioned beyond the user's fingers 50 holding the second extended part 42, as shown in FIG. 6. Subsequently, the barrel 10 is moved downwardly along with the needle unit 20, in the direction of the arrow A in FIG. 6, so that part of the barrel 10 and the needle hub 21 is inserted into the second extended part 42 and the needle 22 passes laterally through the slit 435 of the first sheath part 41. Then, the barrel 10 is pushed forwardly, as in the direction of arrow B in FIG. 6, so that the needle unit 20 is sleeved into the first sheath part 41 and the tip of the needle 22 partially pierces the closed end 412 and is consequently positioned at the central portion of the closed end 412. Finally, the cap 40 is rotated, causing the mutual engagement between the radial teeth 414 of the first sheath part 41 and the radial ridges 211 of the needle unit 20, thereby fixing the needle unit 20 to the cap 40, and both are then detached from the barrel 10 for safe disposal.

It can therefore be appreciated from the above operation in use that, in the process of inserting the barrel 10 along with the needle unit 20 into the cap 40, the tip of the needle 22 is kept in front of the fingers of the user holding the second extended part 42, and that the inserting operation is carried out laterally. Consequently, there is a greatly decreased chance of the user's fingers being accidentally pricked or pierced by the needle. The safety in use is thus enhanced.

Furthermore, the improvement in the present invention is merely directed in the aspect of the cap, the rest of the syringe structure utilizing existing elements employed in the art. Hence, compared with the previous extensive structural modifications made on the syringe attempted by those engaged in the related art in order to prevent users from being accidentally pricked by the needle, the operation and use of the present invention are more convenient and broader and, in terms of production, since only the cap need be modified, the costs are not greatly increased.

Therefore, in the structural design of the present invention according to the foregoing description, not only are the elements simple, but the syringe and needle assembly provides ease of use and improved safety.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A syringe and needle assembly comprising
a barrel having two open ends;
a plunger disposed slidably inside said barrel and extending outward through one of said open ends of said barrel;
a needle unit including a needle hub attached to the other one of said open ends of said barrel, and a needle securely affixed to said needle hub; and
a cap disposed about said needle unit and said barrel as a protective cover and having a curved wall covering said needle unit and said barrel, said wall having an open end adjacent to said barrel, a closed end adjacent to said needle, and an opening extending longitudinally from said open end to said closed end for lateral insertion of said barrel and said needle unit into said cap, said opening being in communication with said open end, said opening having a width sufficient to permit passage of said barrel along a direction transverse to said opening.

2. The syringe and needle assembly according to claim 1, wherein said curved wall is sectioned into a first sheath part for receiving said needle and a second extended part of a cross section greater than said first sheath part for receiving said barrel, said first sheath part being substantially tubular and said second extended part being generally semi-cylindrical.

3. The syringe and needle assembly according to claim 2, wherein said cap further includes a substantially annular shoulder at the juncture of said first sheath part and said second extended part, said opening being narrowed to form a slit in said first sheath part which extends from said annular shoulder to said closed end, said annular shoulder having a through-hole for insertion of said needle hub from said second extended part into said first sheath part.

4. The syringe and needle assembly according to claim 2, wherein said second extended part has an angular width of greater than 180 degrees.

5. The syringe and needle assembly according to claim 3, wherein said first sheath part tapers from said annular shoulder to said closed end.

6. The syringe and needle assembly according to claim 3, wherein said slit tapers from said annular shoulder to said closed end.

7. The syringe and needle assembly according to claim 2, wherein said second extended part is shorter than said barrel and covers only a part of said barrel.

8. The syringe and needle assembly according to claim 2, wherein said needle hub has an outer surface with radial ridges confronting an inner surface of said first sheath part, said first sheath part having radial teeth for engagement with said ridges.

9. The syringe and needle assembly according to claim 1, wherein said closed end has a thickness along a longitudinal direction so that said needle pierces partially said closed end and is thereby positioned.
